(19) United States
(12) Patent Application Publication
(10) Pub. No.: US 2009/0128698 A1
(43) Pub. Date: May 21, 2009

(54) AUDIO SYNCHRONIZER FOR DIGITAL TELEVISION BROADCAST

(76) Inventors: Yoshinori OKAJIMA, Kanagawa (JP); Akihito Tsukamoto, Kanagawa (JP)

Correspondence Address: MCDERMOTT WILL & EMERY LLP, 600 13TH STREET, NW, WASHINGTON, DC, 20005-3096, US

(21) Appl. No.: 12/274,773

(22) Filed: Nov. 20, 2008

(30) Foreign Application Priority Data
Nov. 21, 2007 (JP) P. 2007-301767

(51) Int. Cl. H04N 5/04

(52) U.S. Cl. 348/515; 348/E05.009

(57) ABSTRACT

An audio synchronizer for a digital television broadcast has a clock generation section that generates a fundamental clock pulse by demultiplying a clock pulse of a given frequency, which is generated by multiplying an input clock pulse, by a predetermined demultiplication ratio; a comparison section that compares reference time information included in a broadcast wave with time information counted by means of the fundamental clock pulse generated by the clock generation section; a control section that commands the clock generation section to adjust a frequency of the fundamental clock pulse in accordance with information about a time difference acquired from the comparison section; a sampling clock generation section that generates a sampling clock pulse on the basis of the fundamental clock pulse; and a sampling rate conversion section that performs sampling conversion so as to synchronize the audio sampling clock pulse and audio data included in the broadcast wave with a sampling clock pulse of an audio DAC. The clock generation section inserts a clock pulse having a different demultiplication ratio at intervals equivalent of a predetermined number of clock pulses in accordance with a command from the control section.

### BACKGROUND OF THE INVENTION

1. Field of the invention

The present invention relates to an audio synchronizer for a digital television broadcast.

2. Description of the related art

A related-art digital television broadcast receiver uses a 27-MHz VCXO (voltage-controlled crystal oscillator) for synchronizing a video to audio and achieves audio synchronization by making variable a frequency for supplying a clock pulse to a receiving system LSI. However, under the method, an increase in cost and footprint resultant from addition of the VCXO poses a problem. A method for achieving audio synchronization without use of a VCXO has been proposed as method for resolving the problem. However, a high-speed clock pulse is necessary for realizing the audio synchronization method.

FIG. 8 is a block diagram showing a related-art digital television receiver. The digital television receiver shown in FIG. 8 has a TS processing circuit 810 including circuitry that detects a difference between an internal time counted by an internal system clock and a reference time transmitted from a digital television broadcast station while being multiplexed in a broadcast wave. When the internal time is ahead of the reference time, the digital television receiver performs control to delay the internal clock serving as a reference for counting operation. Conversely, when the internal time is behind the reference time, the digital television receiver performs control to put the internal clock ahead.

For the purpose of controlling the frequency of the internal clock, a PLL circuit using a VCXO is used to make the frequency of a clock pulse signal input to the internal system variable. After being converted by a voltage control section 811 that converts a control signal for the VCXO, difference information detected by the TS processing circuit 810 is input to a VCXO 813 by way of a low-pass filter 812. The frequency of a clock pulse input from the VCXO 813 to the system LSI is controlled by use of a characteristic that makes it possible to linearly change the frequency of the clock pulse imparted to the VCXO 813. The thus-input clock pulse is input to a PLL circuit 814, and an internal system clock pulse is generated by a clock generation circuit 815. The method enables performance of control so as to cause the difference between the internal time and the reference time to come to zero.

The entire system operates by means of taking the system clock pulse as a reference, and video data output from the TS processing section 810 is processed by a video decoder-video output section 816 and output to the outside. Likewise, audio data output from the TS processing section 810 are processed by an audio decoder 817, and the thus-processed data are sampled by means of a sampling clock pulse generated by a sampling clock generation circuit 818. After being subjected, as necessary, to rate conversion processing in a sampling rate conversion section 819, the thus-sampled audio data are converted into an analogue format by an audio DAC 820, and the thus-converted audio data are output to the outside.

The digital television receiver described above processes a video and audio by means of a clock pulse synchronized to the broadcast wave, so that synchronization of the video to audio can be achieved.

In the meantime, Patent Document 1 discloses a method for achieving audio synchronization without use of the VCXO shown in FIG. 9. Under the method, the amount of audio data that are processed by taking an internal clock pulse of the LSI as a reference and that are transferred by means of DMA is managed, and the amount of audio data processed within a given period of time is counted. A determination is made as to whether or not the amount of audio data is smaller than the amount of data originally processed in accordance with time stamp information transmitted from the broadcast station. When the amount of data processed during a given period of time is larger than the amount of originally-processed data, this means that the internal clock quickly performs counting. Conversely, the amount of data processed during a given period of time is smaller than the amount of originally-processed data, this means that the internal clock slowly performs counting. Under the method, a correction is made to a value of the counter that is performing counting operation by means of the internal clock pulse in accordance with a result of the determination, and a clock pulse synchronized with the broadcast wave is reproduced. A sampling frequency input to an audio DAC is changed as a correction corresponding to the amount of difference in the value of the counter. Under the method, the frequency input to the audio DAC is changed while a correction is made to the internal time, thereby achieving audio synchronization.

More specifically, a TS processing block 910 extracts a broadcast wave time and outputs internal time information to a CPU 917 at each transfer interrupt made by a DMAC. After a TS separation block 911 has separated video data from audio data, the video data are input to a Video decoder 912, and audio data are input to an Audio decoder 914. The video data are processed by the Video decoder 912. After being processed by a display control section 913, the video data are output to display means 917. In the meantime, after being processed by an Audio decoder 914, the audio data are transferred to an Audio control section 915 by use of a DMAC 916. The Audio control section 915 performs processing for changing a sampling frequency fs input to an audio DAC 918 by an amount corresponding to a time lag.

Patent Document 1: JP-A-2006-129142

However, under the method for changing the sampling frequency input to the audio DAC, a change in the sampling clock pulse to the audio DAC must fall within a range where an unnatural sound does not arise in terns of an auditory characteristic of the human. The limit of the range is mentioned as about 0.2%. For instance, when converted into a sampling frequency of a 1-segment digital broadcast, the value is equivalent of 48 kHz±96 Hz. Although there are no detailed descriptions about the sampling frequency input to the audio DAC, the following technique is conceived to be down-to-earth. For instance, 16-bit stereo POM data are reproduced by means of a sampling clock pulse of 48.000 kHz for a fixed period of time. When the sampling clock pulse is changed to 48.096 kHz for the next fixed period of time in order to achieve synchronization with the broadcast station, a bit clock pulse output to the DAC must be changed from 651.04 ns to 649.74 ns. A periodic difference is 1.3 ns, and a clock frequency that realizes such a minute difference is 769 MHz. When an attempt is made to perform adjustment in minuter units, a much higher frequency is required.

As mentioned above, the digital television receiver shown in FIG. 8 requires a VCXO and therefore faces a problem in terms of a cost and a footprint. The system shown in FIG. 9 requires a high-frequency clock and faces a problem in terms of packaging practicability.

### SUMMARY OF THE INVENTION

The objective of the present invention is to provide an audio synchronizer for a digital television broadcast without use of a VCXO and a high-frequency clock pulse.

The present invention provides an audio synchronizer for a digital television broadcast, comprising: a clock generation section that generates a fundamental clock pulse by demultiplying a clock pulse of a given frequency, which is generated by multiplying an input clock pulse, by a predetermined demultiplication ratio; a comparison section that compares reference time information included in a broadcast wave with time information counted by means of the fundamental clock pulse generated by the clock generation section; a control section that commands the clock generation section to adjust a frequency of the fundamental clock pulse in accordance with information about a time difference acquired from the comparison section; a sampling clock generation section that generates an audio sampling clock pulse on the basis of the fundamental clock pulse; and a sampling rate conversion section that performs sampling conversion so as to synchronize the audio sampling clock pulse and audio data included in the broadcast wave with a sampling clock pulse of an audio DAC, wherein the clock generation section inserts a clock pulse having a different demultiplication ratio at intervals equivalent of a predetermined number of clock pulses in accordance with a command from the control section.

In the audio synchronizer, the control section computes intervals equivalent of the number of clock pulses in accordance with information about a time difference acquired by the comparison section.

In the audio synchronizer, the sampling clock generation section counts the fundamental clock pulse, thereby generating the audio sampling clock pulse.

In the audio synchronizer, audio data having a sampling clock pulse synchronized with the broadcast wave is input to the sampling rate conversion section; and the sampling rate conversion section outputs audio data having the sampling clock pulse of the audio DAC.

The audio synchronizer for a digital television broadcast of the present invention enables synchronization with a digital television broadcast without use of a VCXO and a high-frequency clock pulse. Consequently, a reduction in the cost of an audio synchronizer and a reduction in footprint can be attained.

### BRIEF DESCRIPTION OF THE DRAWINGS

FIG. 1 is a block diagram showing a digital television broadcast receiving system LSI of an embodiment of the present invention;

FIG. 2 is a block diagram showing the internal configuration of a TS processing section 110 incorporated in the system LSI shown in FIG. 1;

FIG. 3 is a block diagram showing the internal configuration of a clock generation section 111 incorporated in the system LSI shown in FIG. 1;

FIG. 4 is a view showing a waveform of a fundamental clock pulse generated by the clock generation section 111 shown in FIG. 3;

FIG. 5 is a view showing a computing equation for determining a different demultiplied clock insertion interval set value stored in a different demultiplied clock insertion interval set register 313 of the clock generation section 111 shown in FIG. 3;

FIG. 6 is a block diagram showing the internal configuration of a sampling clock generation section 115 incorporated in the system LSI shown in FIG. 1;

FIG. 7 is a block diagram showing a sampling rate conversion section 116 incorporated in the system LSI shown in FIG. 1;

FIG. 8 is a block diagram showing a related-art digital television receiver; and

FIG. 9 is a block diagram of a system that achieves audio synchronization without use of a VCXO.

### DESCRIPTION OF THE PREFERRED EMBODIMENTS

An embodiment of the present invention will be described hereunder by reference to the drawings.

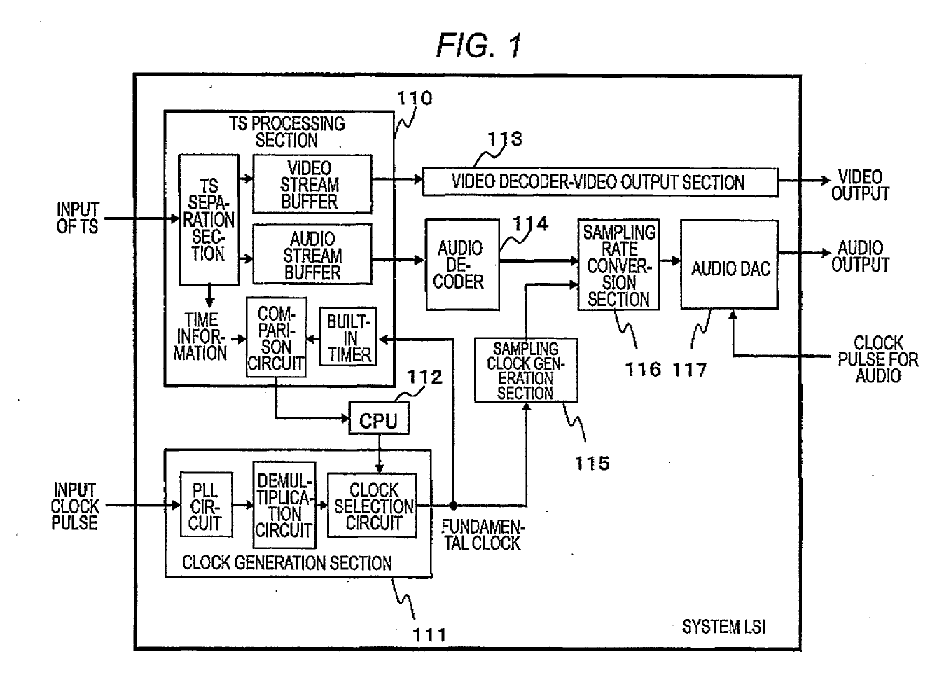

FIG. 1 is a block diagram showing a digital television broadcast receiver system LSI of an embodiment of the present invention. The digital television broadcast receiver system LSI of the present embodiment (hereinafter called simply a “system LSI”) has a TS processing section 110 for processing a transport stream (hereinafter abbreviated as “TS”); a clock generation section 111 for generating a fundamental clock pulse; a CPU 112 that issues a frequency adjustment order to the clock generation section 111 by reference to a comparison result of a time difference between reference time information extracted from a broadcast wave and time information 6 counted by means of the fundamental clock pulse; a video decoder-video output section 113 that processes a video stream; an audio decoder 114; a sampling clock generation section 115; a sampling rate conversion section 116; and an audio DAC 117. The audio DAC 117 does not necessarily be incorporated in the system LSI.

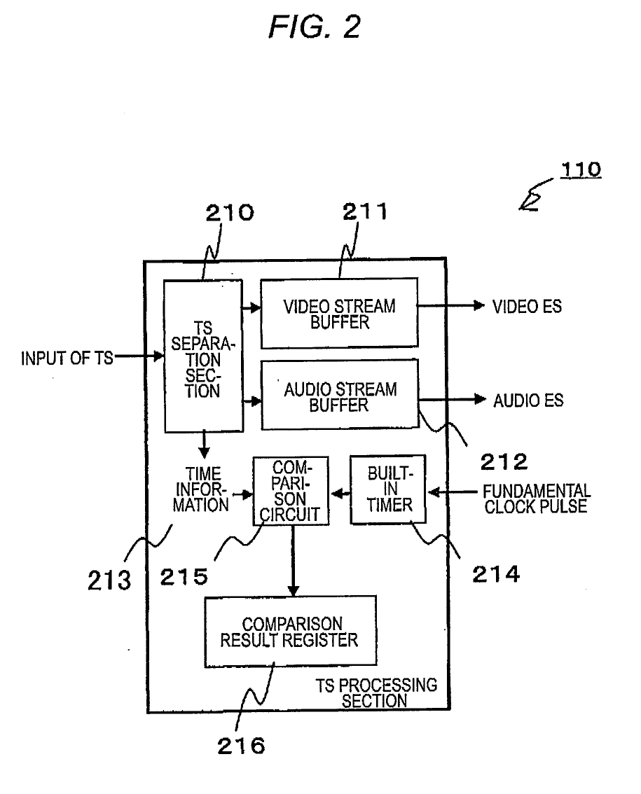

FIG. 2 is a block diagram showing the internal configuration of the TS processing section 110 incorporated into the system LSI shown in FIG. 1. The TS processing section 110 has a TS separation section 210; a video stream buffer 211; an audio stream buffer 212; a built-in timer 214 that counts a fundamental clock pulse; a comparison circuit 215 that compares time information 213 extracted from the TS by means of the TS separation section 210 with a timer value of the built-in timer 214; and a comparison result register 216 that stores a comparison result output from the comparison circuit 215.

The system LSI of the present embodiment performs the following operation. The TS processing section 110 receives a broadcast signal acquired from a digital television broadcast tuner, and the TS separation section 210 of the TS processing section 110 separates the broadcast signal into a video elementary stream (V-ES) and an audio elementary stream (A-ES). At this time, the TS separation section 210 extracts program counter reference information including standard time information from the broadcast signal. The reference time information is stored in a register and updated at a given interval by means of data from the broadcast station.

After being stored in the video stream buffer 211, the video elementary stream (V-ES) is subjected to video decode processing and output processing by the video decoder-video output section 13, and the thus-processed stream is output to the outside of the system LSI. After being stored in the audio stream buffer 212, the audio elementary stream (A-ES) is subjected to audio decoding by the audio decoder 114, whereby PCM data are generated. A fundamental clock pulse synchronized with the broadcast wave output from the clock generation section 111 is used for generating a clock pulse for sampling the PCM data. The PCM data are subjected to sampling conversion in the sampling rate conversions section 116 so as to match a sampling frequency of the audio DAC 117, and the thus-converted data are input to the audio DAC 117. The audio DAC 117 reproduces audio in accordance with a prescribed sampling frequency. In the present embodiment, since audio is reproduced in synchronism with the broadcast wave, synchronization between a video and audio is not disturbed.

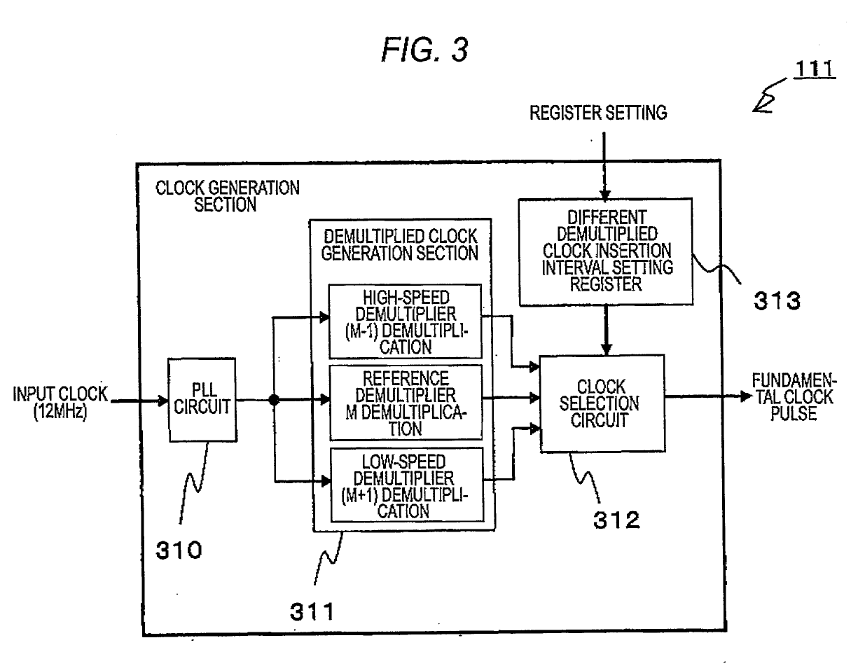

FIG. 3 is a block diagram showing the internal configuration of the clock generation section 111 incorporated into the system LSI shown in FIG. 1. The clock generation section 111 has a PLL circuit 310 that multiplies an input clock pulse, to thus generate a high-frequency clock pulse; a demultiplied clock generation section 311 that generates a plurality of demultiplied clock pulses by means of a set value M (M is a positive integer); namely, a clock pulse demultiplied by (M−1) (hereinafter called an “(M−1)-demultiplied clock pulse”), a clock pulse demultiplied by M (hereinafter called an “M-demultiplied clock pulse”), and a clock pulse demultiplied by (M+1) (hereinafter called an “(M+1)-demultiplied clock pulse”); a clock selection circuit 312 that selects one demultiplied clock pulse from the plurality of demultiplied clock pulses on the basis of a different demultiplied clock insertion interval register value set by the CPU 112, thereby generating a fundamental clock pulse synchronized with the broadcast wave; and a different demultiplied clock insertion interval setting register 313 where the different demultiplied clock insertion interval register value sent from the CPU 112 is stored.

The clock generation section 111 of the present embodiment enables periodic insertion of a clock pulse whose demultiplication ratio differs from that of a clock pulse (demultiplied by M) serving as a reference clock pulse [i.e., an (M−1) or (M+1)-demultiplied clock pulse] and acquisition of a clock pulse having a desired period. Hence, a clock pulse synchronized with a broadcast wave can be generated.

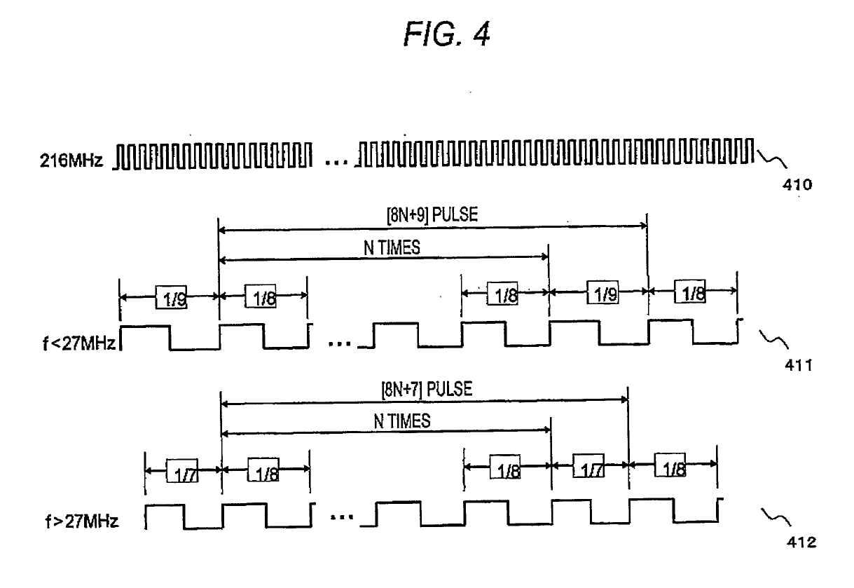

FIG. 4 is a view showing a waveform of the fundamental clock pulse generated by the clock generation section 111 shown in FIG. 3. The fundamental clock pulse of the present embodiment can assume either a clock pulse 411 achieved when the clock frequency is desired to be lower than 27 MHz or a clock pulse 412 that is an example clock waveform achieved when the clock frequency is desired to be made higher than 27 MHz, by means of demultiplying the 216-MHz clock pulse 410 multiplied by the PLL circuit 310.

Descriptions of the example waveform are premised on the followings. A clock pulse input to the system; for instance, a 12-MHz source oscillation clock pulse commonly used in a portable cellular phone, is multiplied by a factor of 18 by means of the PLL circuit 310, to thus generate a 216-MHz clock pulse. In order to acquire a system frequency of an MPRG2-TS, a 27-MHz clock pulse obtained by demultiplying the 216-MHz clock pulse 410 by a factor of 8 (hereinafter called an “8-demultiplied clock pulse”) is generated. Further, a 30.86-MHz clock pulse demultiplied by a factor of 7 (hereinafter called a “7-demultiplied clock pulse”) and a 24-MHz clock pulse demultiplied by a factor of 9 (hereinafter called a “9-demultiplied clock pulse”) are generated for adjusting the clock frequency. When the clock frequency is desired to be made higher with respect to a frequency of 27 MHz, the frequency can be made higher by periodic insertion of the 7-demultiplied clock pulse into the 8-demultiplied clock pulse as indicated by reference numeral 412 shown in FIG. 4. In the meantime, when the clock frequency is desired to be made lower with reference to a frequency of 27 MHz, the frequency can be made lower by periodic insertion of the 9-demultiplied clock pulse into the 8-demultiplied clock pulse as indicated by reference numeral 411 shown in FIG. 4. Thus, the frequency of the fundamental clock pulse is adjusted by insertion of a clock pulse having a different demultiplication ratio (a demultiplication ratio of 7 and a demultiplication ratio of 9) at intervals of an N number of 8-demultiplied clock pulse. The system can adopt a similar configuration by use of a frequency differing from the clock frequency described in connection with the present embodiment. The intervals N at which a clock pulse having a different demultiplication ratio is periodically inserted into the 8-demultiplied clock pulse is indicated by the different demultiplied clock insertion interval register value set by the CPU 112.

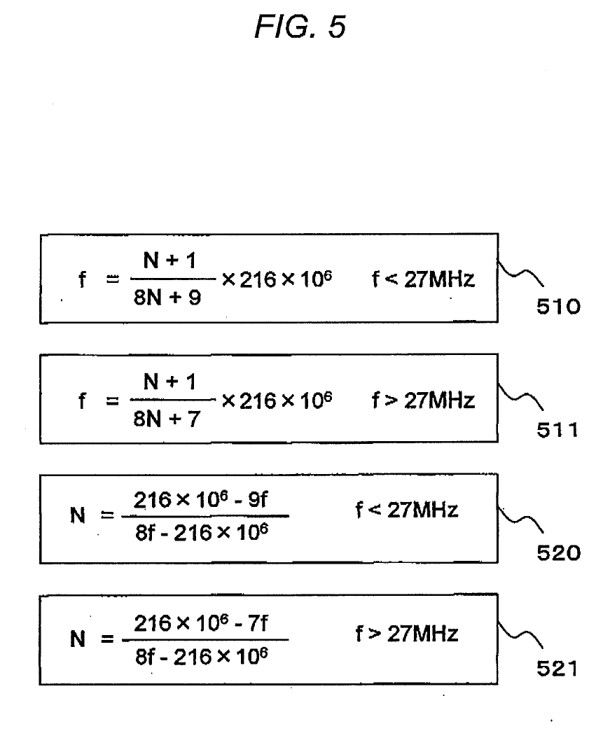

FIG. 5 is a view showing a computing equation for determining the different demultiplied clock insertion interval set value stored in the different demultiplied clock insertion interval setting register 313 of the clock generation section 111 shown in FIG. 3. According to the equation for computing a different demultiplied clock insertion interval of the present embodiment, provided that the clock frequency is “f” and that a clock pulse having a different demultiplication ratio is periodically inserted once at intervals of an number of N 8-demultiplied pulses, the clock frequency “f” that is higher than 27 MHz is expressed by Equation 510 shown in FIG. 5, and the clock frequency “f” that is lower than 27 MHz is expressed by Equation 511 shown in FIG. 5. From these equations, the different demultiplied clock insertion interval N is expressed by Equations 520 and 521.

The different demultiplied clock insertion interval N computed by the CPU 112 by means of the equations is stored in the different demultiplied clock insertion interval setting register 313 of the clock generation section 111, whereby the clock selection circuit 312 inserts a clock pulse having a demultiplication ratio automatically determined by the intervals N, thereby generating the fundamental clock frequency. The clock generation section 111 of the present embodiment enables generation of an uniform fundamental clock pulse by insertion of a different demultiplied clock pulse.

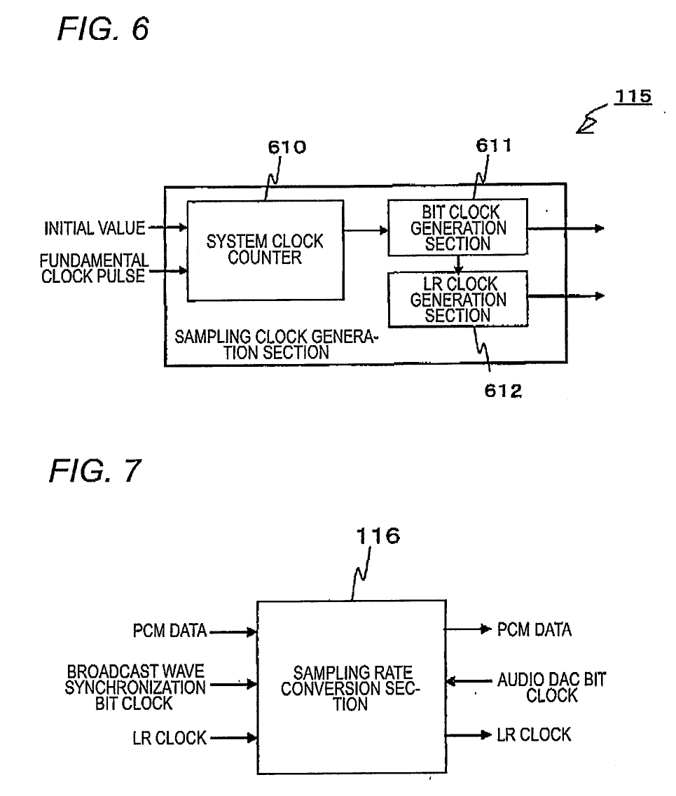

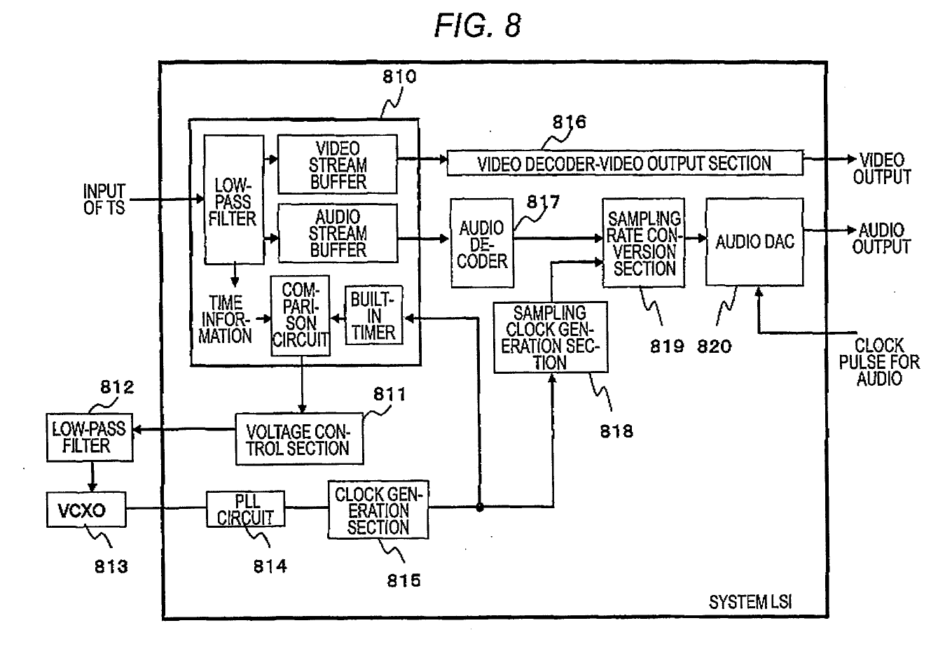

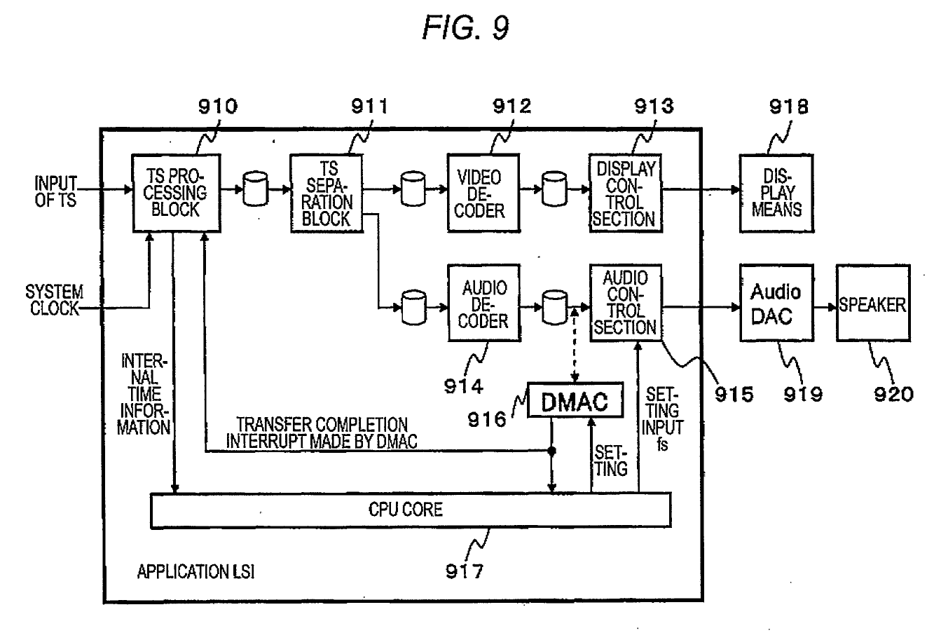

FIG. 6 is a block diagram showing the internal configuration of the sampling clock generation section 115 incorporated in the system LSI shown in FIG. 1. The sampling clock generation section 115 has a counter 610 for counting a fundamental clock pulse; a bit clock generation section 611 for generating a bit clock pulse from the value of the counter; and an LR clock generation section 612 for generating an LR clock pulse from the bit clock pulse.

The sampling clock generation section 115 of the present embodiment enables generation of an audio sampling clock pulse not from the internal clock pulse of the LSI not synchronized with the broadcast wave but from the fundamental clock pulse subjected to synchronization adjustment.

FIG. 7 is a block diagram showing the sampling rate conversion section 116 incorporated in the system LSI shown in FIG. 1. The sampling rate conversion section 116 receives, as an input, the bit clock pulse synchronized with the broadcast wave, the LR clock pulse, and the PCM data from the audio decoder 114 and outputs the LR clock pulse and the PCM data converted so as to synchronize to the bit clock pulse from the audio DAC 117.

The sampling rate conversion section 116 of the present embodiment can absorb discontinuity of the sample clock pulse synchronized with the broadcast wave, an asynchronous characteristic of the sample clock pulse of the source signal, and an asynchronous characteristic of the sample clock pulse of the audio DAC 117. In the present embodiment, the different demultiplied clock pulse is inserted into the sampling clock pulse to be input, and hence the sampling clock pulse discontinuously changes depending on the insertion/noninsertion of the pulse and the number of inserted pulses. Further, the sampling clock pulse synchronized with the broadcast wave and the sampling clock pulse of the audio DAC 117 are not originally, completely identical with each other. Hence, if reproduction is performed at a sampling rate remaining unchanged, sound quality will be degraded. Therefore, conversion of the sampling rate performed by the sampling rate conversion section 116 is required. By means of conversion of the sampling rate, the discontinuity of the signal sample clock pulse, the asynchronous characteristic of the sample clock pulse of the source signal, and the asynchronous characteristic of the sample clock pulse of an audio-system DAC can be absorbed.

As described above, the system LSI of the present embodiment makes it possible to equally control the reference time interval multiplexed in the broadcast wave and a time of a period measured by the built-in timer 214 that counts the fundamental clock pulse by means of adjusting the different demultiplied clock insertion interval N and inserting a different demultiplied clock pulse at every different demultiplied clock insertion interval N. Moreover, since the number of clock pulses acquired within a given period of time can be made uniform, deterioration of sound quality occurred at the time of conversion of a sampling rate for reproducing sound can be minimized. Consequently, synchronization of audio in a digital television broadcast can be realized without use of a VCXO and a high-frequency clock pulse by appropriately adjusting the frequency of the fundamental clock pulse and reproducing PCM data whose sampling rate has been converted.

The audio synchronizer for a digital television broadcast of the present invention is useful as an audio synchronizer, and the like, for use with a digital television broadcast without use of a VCXO and a high-frequency clock pulse, and enables achievement of a reduction in cost and footprint. Hence, the audio synchronizer can be effectively applied to an electronic device for which a reduction in size and weight is sought, such as a portable cellular phone and a PDA.

What is claimed is:

1. An audio synchronizer for a digital television broadcast, comprising:
a clock generation section, generating a fundamental clock pulse by demultiplying a clock pulse of a given frequency, which is generated by multiplying an input clock pulse, by a predetermined demultiplication ratio;
a comparison section that compares reference time information included in a broadcast wave with time information counted by means of the fundamental clock pulse generated by the clock generation section;
a control section that commands the clock generation section to adjust a frequency of the fundamental clock pulse in accordance with information about a time difference acquired from the comparison section;
a sampling clock generation section that generates an audio sampling clock pulse on the basis of the fundamental clock pulse; and
a sampling rate conversion section that performs sampling conversion so as to synchronize the audio sampling clock pulse and audio data included in the broadcast wave with a sampling clock pulse of an audio DAC, wherein
the clock generation section inserts a clock pulse having a different demultiplication ratio at intervals equivalent of a predetermined number of clock pulses in accordance with a command from the control section.

2. The audio synchronizer according to claim 1, wherein the control section computes intervals equivalent of the number of clock pulses in accordance with information about a time difference acquired by the comparison section.

3. The audio synchronizer according to claim 1, wherein the sampling clock generation section counts the fundamental clock pulse, thereby generating the audio sampling clock pulse.

4. The audio synchronizer according to claim 1, wherein audio data having a sampling clock pulse synchronized with the broadcast wave is input to the sampling rate conversion section; and
the sampling rate conversion section outputs audio data having the sampling clock pulse of the audio DAC.
